(19) United States
(12) Patent Application Publication
(10) Pub. No.: US 2012/0097040 A1
(43) Pub. Date: Apr. 26, 2012

(54) FILTER HOLDER

(76) Inventors: Jean-Pierre Levi, Nice (FR); Mario Levi, Nice (FR)

(21) Appl. No.: 13/320,369

(22) PCT Filed: May 5, 2010
(86) PCT No.: PCT/EP10/56101

§ 371 Date: Jan. 4, 2012

(30) Foreign Application Priority Data
May 15, 2009 (FR) 0953230

(51) Int. Cl. A47J 31/06

(52) U.S. Cl. 99/285

(57) ABSTRACT

A filter holder (1) for coffee grinding, includes a handle (3), a filter-carrying cup (2), and identification elements including a radio label. The filter holder is applicable to coffee grinders and to machines used to prepare coffee drinks.

The present invention concerns a filter holder for receiving ground coffee.

It also concerns a system for preparing drinks using ground coffee which advantageously consists of a coffee grinder and a machine for preparing a coffee drinks.

In this field, and especially in the field of so-called espresso coffees, an assembly holding a dose of ground coffee consisting of a filter holder is commonly used. The filter holder contains a gripping part in the form of a handle and a receiving part with a ground coffee filter in a filter-carrying cup. The filter-carrying cup may be assembled in the holder permanently or be removable and generally be received in a support, for instance with overall cylindrical hollow form, generally called a filter-carrying cup.

The bottom of the device, below the filtering bottom of the cup, contains a discharge consisting of one or more outlets created to allow the drink(s) to evacuate.

This kind of filter holder co-acts either with the mouth of a coffee grinder for loading the device with ground coffee or with a machine for preparing the drink by the injection of hot water through the ground coffee and making of the drink.

The filter-carrying cup of the filter holder is dedicated to holding a predetermined quantity of ground coffee. Generally, two or more coffee drinks can be made simultaneously. The user, in particular the operator of the coffee machine, chooses the appropriate filter holder device with cup adapted to the number of drinks that he would like to make. Traditionally, he has to adapt the machine manually, whether this is a coffee grinder or a machine for making a coffee drink, to the particular dose based on the filter holder used which presents the required volume of the cup with filtering bottom. These manual actions increase the time for making the drink and raise problems of reliability since they are not without the risk of the operator making a mistake.

The applicant has already sought to solve this problem by proposing a detection system as described in publication EP-A1-280 594 which concerns a system for detecting doses for the filter holder device comprising a cup. The technique used according to this anteriority consists in using Hall-effect magnetic sensors with a predetermined coding system and following the rotational positioning movement of the filter holder in order to identify different types of filter holders.

Although giving overall satisfaction, the device in question does have certain limitations. Initially, the number of filter holders that can be detected is limited by the inherent construction of the sensor. Therefore, this device cannot be extended to a large number of detections, in particular the volume of ground coffee or the parameters for preparing the drink, which may vary according to the quality of the type of coffee.

Moreover, this device enables a reliable reading to be obtained when the filter holder, passing in front of the magnetic sensors, is operated correctly. A particular movement is therefore required and the type of detection achieved imposes strong constraints on the design of the reading system which has to be positioned close to the filter holder to be detected, thereby leading to design and size constraints, and a non-negligible cost.

The present invention overcomes all or part of the shortcomings encountered with current techniques and for this purpose puts forward a filter holder for use with ground coffee comprising a handle, a filter-carrying cup and means of identification, the means of identification comprising a radio tag.

By using a radio tag (RFID type technology for radio frequency identification), the invention lessens the constraints associated with the necessary proximity of the identifier and the reading means. A no-contact system also protects the identification means, notably by the use of a protective shell.

The number of identifying types is moreover much wider and the same filter holder can be easily adapted to a new identifier when the radio tag is removable.

Although metal environments are generally thought to constitute obstacles to the correct operation of radio-frequency identification systems, in this case the applicant has observed with surprise that his invention gives entire satisfaction, particularly when the tag is enclosed within a protective shell and a limited detection distance is defined.

Advantageously, the identification by radio tag is combined with the presence detection means at the mouth of the coffee grinder or the mouth of the drink-making machine so as to combine these data in order to control operation of the system.

Other aims and advantages will appear during the description which follows which describes a preferred embodiment of the invention.

First of all, below are different but non-exhaustive advantages of the invention:

the cup is placed in a support connected to the handle, the radio tag being added on the outer wall of the support,

the radio tag is covered with a protective shell,

the shell is fixed removably on the support,

the radio tag entirely covers the shell.

The invention also concerns a system for preparing drinks using ground coffee and comprising a removable body, a radio tag reader and treatment means capable of generating a control signal when operating based on the identification data.

This system may have the following non-exhaustive variants:

the reader is placed so as to be situated less than 15 cm from the radio tag when the filter holder is inserted by the receiving body,

it includes means for detecting the presence of a filter holder at the receiving body,

it includes control means configured to generate the operation control signal on the cumulated conditions of a presence detection signal and a radio tag reading,

the radio tag reading is configured so as to only be activated when a presence detection condition is detected.

The attached drawings are given as examples and do not constitute a restrictive version of the invention. They only represent one embodiment of the invention and will enable it to be easily understood.

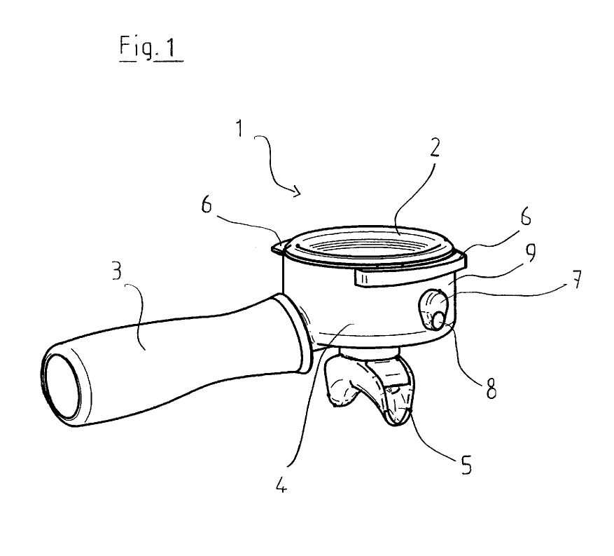

FIG. 1 is a view in perspective of one method of executing the filter holder.

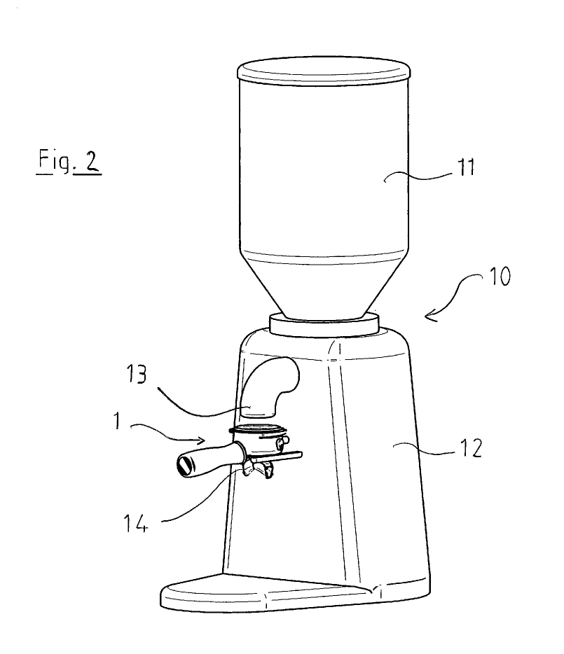

FIG. 2 shows a view in perspective of a system equipped with a filter holder.

By reference to FIG. 1, it has to be remembered that filter holder 1 in its conventional configuration is equipped with a handle 3 and a cup 2 forming a filtering bottom and capable of receiving a predetermined dose of ground coffee. In addition, device 1 is advantageously equipped with a support 4, the wall 9 of which defines an internal cavity in which is housed cup 2 and on the upper surround of which applies cup 2.

Two bayonets 6 advantageously project from wall 9 in order to allow assembly of the co-acting components with the cup-carrying mouth of a machine such as a machine for preparing drinks or a coffee grinder.

In the lower part, at the liquid discharge, device 1 is equipped with a drink discharge 5 comprising one or several outlets.

The radio tag according to the invention is advantageously positioned on wall 9 outside support 4 or on cup 2 inside shell 7, advantageously made of a plastic material. Moreover, in a preferred arrangement, shell 7 has a hole for receiving a screw 8 used to assemble removably the radio tag on device 1. This makes it easy to replace the radio tag in the event of its malfunction or when it is required to change the identifier of filter holder 1.

The use of a passive tag (without integrated battery) overcomes the need for any maintenance. The digital identification achieved by the radio tag may use a communication and formatting standard of the type OPC-96.

Radio tag 1 thus described may co-act with a coffee grinder 10 and/or a machine for making drinks in order to constitute a radio identification system.

In the case presented in FIG. 2, a mill 10 has conventionally a base 12 and an opening 11 for receiving and storing ungrounded coffee beans thereby making it possible to produce ground coffee that will be delivered at mouth 13 to cup 2 of filter holder 1 in this position.

Two means for positioning filter holder 1 are advantageously present at the mouth as two receiving bodies 14, shown here in the form of two parallel rods bearing on a lower part of support 4.

The system comprises a radio tag reader capable of emitting radio-frequency signals enabling the activation of the radio tag placed nearby so as to generate the required identifying transmission. Conventional reading technologies may be used, especially concerning the communication frequency.

Advantageously, a reader with limited range is used so as to avoid interference by the detection of several radio tags. The applicant has observed that a range of less than 15 cm will give satisfaction. The reader is therefore placed in the system so that the distance separating the co-action zone of filter holder 1 with mouth 30 and the reader is less than the range of the latter.

In a preferred arrangement, the identifying reader is combined with a presence detection at the mouth of the machine. Capacitive or inductive type presence detection means may be used. Optical detection may also be used.

According to one possibility, the radio tag reader is only activated when the presence detection means detect the presence of a filter holder at the mouth of the machine.

Moreover, operation of the machine (in particularly start-up of the grinder or tripping of the machine for drinks preparation by infusion and especially the pump) only occurs in the cumulated conditions of the detection of a recognised identifier and a presence detector.

This dual safety system ensures that the operations run smoothly.

At reader level, a table of data makes it possible to advantageously ensure that the radio tag identifier corresponds to an attribute. According to one advantageous solution, the attribute constitutes a quantity of ground coffee. However, other attributes are used, especially the particular quality of a coffee, the ground coffee granulometry or any other attribute. The identifier may also be used to generate an attribute for the type of filter holder so as to avoid co-action between a coffee machine or a grinder on the one hand and filter holder on the other within a same system but not able to co-act correctly. This method of operation avoids the operator using filter holders that are not adapted to the machine and could damage the system.

### REFERENCES

1. Filter holder
2. Cup
3. Handle
4. Support
5. Drink discharge
6. Assembly bayonet
7. Shell
8. Screw
9. Wall
10. Grinder
11. Opening
12. Base
13. Mouth
14. Receiving body

1. Filter holder (1) for ground coffee comprising a handle (3), a filter holder (2) and identification means, characterised in that the identification means contain a radio tag.

2. Device according to claim 1 in which cup (2) is placed in a support (4) connected to handle (3), the radio tag being added on outer wall (9) of support (4).

3. Device according to claim 2 in which the radio tag is covered by a protective shell (7).

4. Device according to the claim 3 in which shell (7) is fixed removably on support (4).

5. Device according to claim 4 in which the radio tag is entirely covered by shell (7).

6. System for preparing drinks using ground coffee and comprising a removable receiving body (14) of a device according to claim 1, a radio tag reader and treatment means capable of generating an operation control signal based on the identification data.

7. System according to claim 5 in which the reader is placed so as to be situated less than 15 cm from the radio tag when filter holder (1) is inserted in receiving body (14).

8. System according to claim 6 comprising means for detecting the presence of filter holder (1) at receiving body (14).

9. System according to claim 8 comprising control means configured in order to generate the operation control signal on a cumulated presence detection and radio tag reading.

10. System according to claim 8 in which the radio tag reading is configured so as to only be activated on a presence detection signal.

11. System according to claim 6 comprising a machine for preparing drinks by infusing ground coffee.

12. System according to claim 6 comprising a coffee grinder.
